(19) United States
(12) Patent Application Publication
(10) Pub. No.: US 2024/0167278 A1
(43) Pub. Date: May 23, 2024

(54) BENDABLE STRUCTURAL SHEATHING

(71) Applicant: Specialty Coating & Laminating LLC, Doswell, VA (US)

(72) Inventor: Geoffrey M. Baldwin, Mechanicsville, VA (US)

(73) Assignee: Specialty Coating & Laminating LLC, Doswell, VA (US)

(21) Appl. No.: 18/516,879

(22) Filed: Nov. 21, 2023

Related U.S. Application Data
(60) Provisional application No. 63/427,111, filed on Nov. 22, 2022.

(51) Int. Cl. E04C 2/32; B32B 1/00; B32B 3/26; B32B 5/18; B32B 21/02; B32B 21/04; B32B 21/08; B32B 27/32; E04C 2/296

(52) U.S. Cl. CPC E04C 2/324; B32B 1/00; B32B 3/266; B32B 5/18; B32B 21/02; B32B 21/042; B32B 21/047; B32B 21/08; B32B 27/32; E04C 2/296; B32B 2307/304; B32B 2307/7145; B32B 2307/7265; B32B 2307/7376; B32B 2419/00

(57) ABSTRACT

A structural sheathing product used in construction that is adapted to wrap around a corner or otherwise bend for specific installations. In the preferred embodiment, a pre-scored sheathing board creates a hinge-like portion enabling an efficient and clean bend of the sheathing around a corner without fracturing or damaging the exterior surface of the sheathing, in particular, without damaging any exterior water barrier of such sheathing. The pre-scored sheet of sheathing board may have multiple locations of scoring lines. The scoring may be along the vertical length or horizontal length of the sheet of sheathing or both. A method of manufacture of the pre-scored sheathing board is also disclosed herein.

This application claims the benefit of the filing date of U.S. Provisional Patent Application Ser. No. 63/427,111 filed on Nov. 22, 2022.

### FIELD OF THE INVENTION

This invention relates to structural sheathing board that is used in building construction.

### BACKGROUND

Structural sheathing is used and has for many years been used as a support material when mounted onto wall studs during new wall construction. Structural sheathing is typically sold as rigid sheets in 4′×8′ board sections. These sections are attached to wall studs during the construction process, and improve the structural integrity and air filtration performance of the wall.

The structure of traditional sheathing products is typically a multilayer laminate that is relatively thick. As a result of its thickness and structure, it is impractical and difficult to bend conventional sheathing materials. Moreover, the bending of conventional sheathing can be destructive of that sheathing. In the example of insulated structural sheathing, bending of a board can be even more difficult and destructive. There is, therefore, a need for a structural sheathing product which can be applied in a single sheet around a corner, or in any similar application, without significantly comprising the sheathing product's ability to provide a barrier against the infiltration of air, liquid water, moisture and/or water vapor.

### BRIEF DESCRIPTION OF THE DRAWINGS

FIG. 1 is a side view of a flat sheet of pre-scored sheathing board.

FIG. 2(a) shows the exterior surface of a flat sheet of pre-scored sheathing board.

FIG. 2(b) shows the interior surface of a flat sheet of pre-scored sheathing board.

FIG. 2(c) is a the pre-scored section in a bent configuration.

FIG. 3(a) shows the exterior surface of a flat sheet of pre-scored sheathing board with multiple scores.

FIG. 3(b) shows the interior surface of a flat sheet of pre-scored sheathing board with multiple scores.

FIG. 4(a) shows the exterior surface of a flat sheet of pre-scored sheathing board using an alternate scoring method.

FIG. 4(b) is the pre-scored section of a flat sheet of pre-scored sheathing board using the alternate scoring method.

FIG. 4(c) is the pre-scored section of a flat sheet of pre-scored sheathing board using the alternate scoring method in a bent configuration.

FIG. 5(a) illustrates unbent pre-scored sheathing board bearing perforated scoring.

FIG. 5(b) illustrates bent pre-scored sheathing board bearing perforated scoring.

FIG. 5(c) is a vertical view of pre-scored sheathing board bearing perforated scoring.

FIG. 5(d) is a side view of a perforated pre-scored sheathing board in bent configuration.

FIG. 6 illustrates a first method of pre-scoring sheathing board.

FIG. 7 illustrates a second method of pre-scoring sheathing board.

FIG. 8(a) reflects a side view of pre-scored insulative sheathing board having a v-cut.

FIG. 8(b) reflects a side view of pre-scored insulative sheathing board having a v-cut in bent configuration.

FIG. 9(a) reflects a side view of an alternate embodiment of pre-scored insulative sheathing board.

FIG. 9(b) reflects a side view of an alternate embodiment of pre-scored insulative sheathing board in bent configuration.

FIG. 10 is a perspective view of two embodiment of pre-scored insulative sheathing board when installed.

FIG. 11 is a perspective view of an alternate embodiment of pre-scored insulative sheathing board when installed.

### DETAILED DESCRIPTION

The present invention is a structural sheathing product that is adapted to wrap around a corner. Specifically, a pre-scored sheathing board which enables an efficient and clean bend of the sheathing around a corner without fracturing or damaging the exterior water barrier surface of such sheathing. The sheet of sheathing may have multiple locations of scoring lines. The scoring may be along the vertical length or horizontal length of the sheet of sheathing or both. It is also possible for angled scoring, for instance, to adapt the sheathing to an angled wall such as a roof line. The bending is enabled by the scoring and allows the sheathing to improve the structural support of a wall around a corner or other wall connection. This sheathing also potentially improves the air infiltration performance of a building.

At present, sheets of sheathing are typically sized in 4′×8′ boards in order to match common construction specifications. Wall studs are commonly mounted 16″ apart, so a 4′ wide sheathing board can span four studs. Adjacent sheathing is either attached along the butt sides at a common stud or overlap on a common stud. By wrapping a sheathing around a corner, it is possible to attach a single sheathing board to a first wall and to one or more adjacent studs in a neighboring, perpendicular wall. The added benefits of better shoring and sealing of the corner may result. The bending is enabled by the scoring on that sheet of sheathing. The use of the preferred embodiment eliminates the need to tape, or otherwise seal, any seam when the sheathing is bent around a corner.

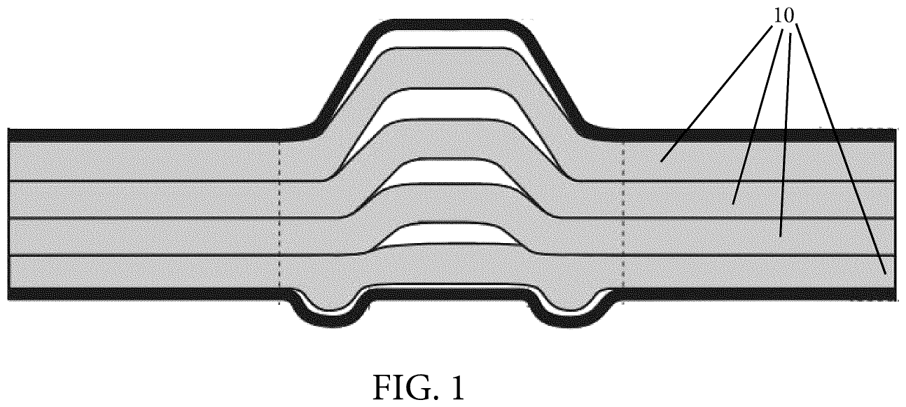

The sheathing material as described herein is typically a multi-layer material. It may consist of a structural layer alone, or a structural layer along with other layers. The structural layer may range from about 50-150 mils in thickness, or alternatively about 75-125 mils. Or alternatively about 80-100 mils. The structural layer is comprised of two or more sub-layers 10 as shown in FIG. 1. These sub-layers include one or both inside and outside water-resistant barrier layers. The sub-layers may be formed of polyolefins, polyester, polyethylene, polypropylene, fiberboard, paper or other known structural materials. The thickness of these layers may be 0.0005″ to 0.060″, or alternatively 0.020″ to 0.040″. For instance the outer water resistant barrier layers may be formed of water impermeable and be a very low vapor to high permeable vapor permeable film formed of microporous or monolithic coatings having a thickness of 0.001″, or alternatively about 0.0005 to 0.0025″. There are many various and interchangeable materials for the layers that may depend on a sheathing application both from a construction perspective and a geographical or local weather perspective. The sheathing board may be these layers alone, because they provide good structural integrity and have water resistant advantages. A commercial embodiment of a structural sheathing board alone is sold under the brand name Barricade Thermo-Brace®. This board has a thickness range of from 0.050 to 0.200 inches, or still further alternatively 0.060 to 0.140 inches. The weight of this board is from 160 lbs./MSF to 750 lbs./MSF, or alternatively 225 lbs./MSF to 510 lbs./MSF.

In other examples, a structural sheathing board may be laminated or otherwise bonded to an insulative foam layer to provide insulating properties. By way of example, the insulative foam layer may be composed of graphite expanded polystyrene (GPS), expanded polystyrene (EPS), extruded polystyrene (XPS), or polyisocyanurate (ISO). Other foam products may be alternatively used as well.

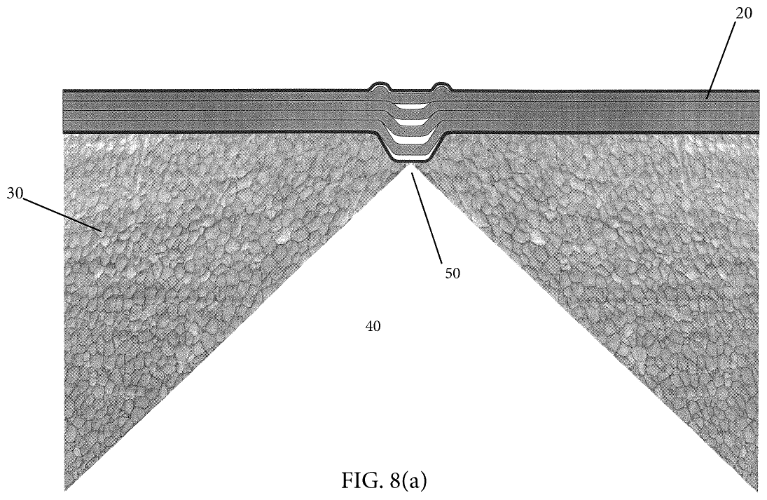

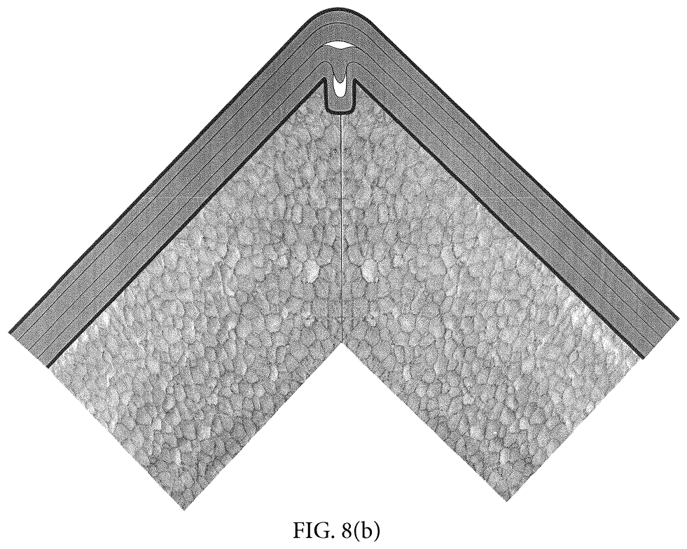

In such embodiments, a structural layer 20 is laminated to one side of an insulative foam core layer 30 as shown, for example, in FIGS. 8(a-b). This structural layer has multiple sub-layers that form it as described above. In one example, a water resistant barrier layer is laminated to a water resistant fiberboard layer. The fiberboard layer may alternatively have a second water resistant barrier layer laminated to it on the opposite side that the first barrier layer in order to encapsulate the fiberboard layer. In another alternative, there may be multiple layers of fiberboard layer and water resistant barrier layer. The structural layer of a sheathing board herein can have one or multiple plies in order to meet the structural requirement of this layer. One commercial example of such a fiberboard structural insulative sheathing is the Barricade Thermo-Brace SIB® board. The formed structural sheathing board, like the example Barricade Thermo-Brace SIBR board, can have a weight of 160 to 750 lbs. per MSF, or alternatively 225-350 lbs. per MSF. The combined thickness of this insulated structural sheathing is 0.350″ to 12.0″, or alternatively 0.43″ to 3.0″. This thickness may vary depending on insulative needs. With respect to the structural sheathing board component 20 of the insulated board, regardless of how many plies there may be in this structural portion, it is preferred, but not required, that the farthest outside of the structural layer, on the other side of the structural layer from the core layer, there is the water resistant barrier layer. This layer is typically a polyethylene or other polymeric material that is substantially impermeable to liquid moisture ingress and air infiltrate. This outside protective skin layer protects the fiberboard layers from absorbing moisture and is very mold resistant. It also protects against compositional decay of interior fiberboard layers and provides improved dimensional stability to varying humidity and temperature conditions.

The water resistant barrier layer can be any polymeric material that can substantially block liquid moisture and/or air flow. It may be polyethylene, polyester, PVC, polyamide (nylon) polypropylene or copolymers thereof. This barrier layer may be melt-coated onto the fiberboard layer, or alternatively it may be adhesive-coated with an aqueous or liquid-based coating, such as acrylic or polyurethane, and applied under pressure onto the fiberboard layer.

In an alternate embodiment, a facer layer may be laminated to the opposite side of the foam core layer from the structural component layer. The facer layer is formed of a water resistant barrier material. It may be the same material as the barrier layer described in connection with the structural component layer. Its purpose is to prevent liquid moisture from passing into the foam layer. The facer layer may alternatively be a metallized polymer. Still further alternatively, a separate metal foil layer can be laminated to the barrier layer. In such installations when the foam layer is positioned on the exterior surface of the board, it is essential that the most outside facer layer is a water barrier layer to prevent or minimize the ingress of liquid moisture into the foam. This facer layer may be melt-coated onto the foam layer. Alternatively, an adhesive may be applied to the back of the facer layer which is then laminated to the foam core layer.

The water resistant barrier layers that are laminated to the inside and outside faces of the sheathing board (on the outward faces of the structural and facing layers respectively) may be impermeable to air and liquid water moisture and to water vapor, or alternatively those layers may be formed of a “breathable” layer such as a housewrap material. A housewrap material is defined as a microporous, monolithic or microperforated coating applied to a substrate, including but not limited to a fabric or paperboard. For the purposes of a structural board as described herein, a housewrap material is defined as a film that repels liquid water but allows water vapor to pass through it. When impermeable water resistant barrier layers are used, e.g. the solid polymer films identified earlier herein, the perm rating, which is the standard measure of the water vapor permeability of a material, of the assembled composite board is between about 0.1 and 1. When a “breathable” housewrap material is used as the water resistant barrier layer, the entire composite board including this layer breathes water vapor at a range of 1-20 perms, and alternatively 1.5-15 perms. The US perm is defined as 1 grain of water vapor per hour, per square foot, per inch of mercury. It is typically tested in accordance with ASTM E96 Procedure a or b.

The fiberboard structural component layer is typically formed using laminated kraft paper or recycled paperboard having a total laminated thickness of about 1/32 to ¼th of an inch, or alternatively about 1/16th to 5/32nd of an inch. In one example of a commercially available Barricade Thermo-BraceR sheathing, the fiberboard sheathing is a multi-ply of kraft and moisture barrier layers with a total thickness of about ⅛^{th} of an inch. This thickness of the structural layer is significant for practical reasons. When laminated to a one inch foam board, the resulting sheathing can be installed with nails or staples or similar tools. This is compared with an oriented strand board (OSB) structural layer in other products that is commercially relatively thicker at about 7/16 of an inch, at least. A laminated OSB on a one inch foam board product, therefore, cannot be installed with regular staples. Instead, the OSB on foam boards require use of nails or screws to attach to wall studs and are therefore more time-consuming and labor intensive to install. (Also, the OSB is by its nature very absorbing of water and subject to degradation and/or mold over time.)

The sheathing board size, as measured in width by length, is traditionally about 4′×8′. For the present invention, on one edge of the sheathing, up to an additional 16″ of width flap may be added to capture a traditional spacing of an additional wall stud on a perpendicular wall. It is also possible to add an additional flap to the length of the sheathing sheet. By adding to the width of the sheet, then the sheathing is able to wrap around corners. By adding a flap to the length of the sheathing, then the sheathing may wrap around or under a wall footer or around and on top of a top wall header to more securely fix a wall in place. The added width may be anywhere from about 1 inch to 50 inches. It could be more if intended and engineered for a specific application. The added length may be about 4 to about 48 inches as well, and this may likewise be varied and engineered for a specific purpose. Accordingly, the sheathing board width size may be from four feet to eight feet while the length will range from eight to twelve feet in length. In use, the overlap could be as short as 1″ at the corner and attach to the adjacent side of the same 2×4 on the corner and, or, in an alternate embodiment, the sheet could also be made at, for instance, 96″ width with a score allowing a full wrapped corner having 48″ of coverage on each side of the corner.

The scoring of the sheathing that enables the efficient bending of that sheathing is pre-scored. This would be accomplished at a manufacturing site where the sheathing is fabricated. The scoring may be accomplished by mechanical means to narrow or pre-weaken a straight line along the length or width or at a cross angle on the sheathing creating a “hinge”.

In preferred embodiments which include a layer of insulative foam board attached to one side of the structural component board, the foam layer may be modified in order to ensure a proper fit during installation and in order to maximize the insulative properties of the sheathing. In a first embodiment, as shown in FIG. 8(a), a V-shaped portion 40 of the insulative foam is removed, with the point of the V-cut 50 proximate the board scoring. As a result of the V-shaped aperture, when the board is bent and installed around a corner, the foam is able to close on itself, i.e., the two surfaces that form the inside of the “v” are pressed up against one another (as shown in FIG. 8(b)).

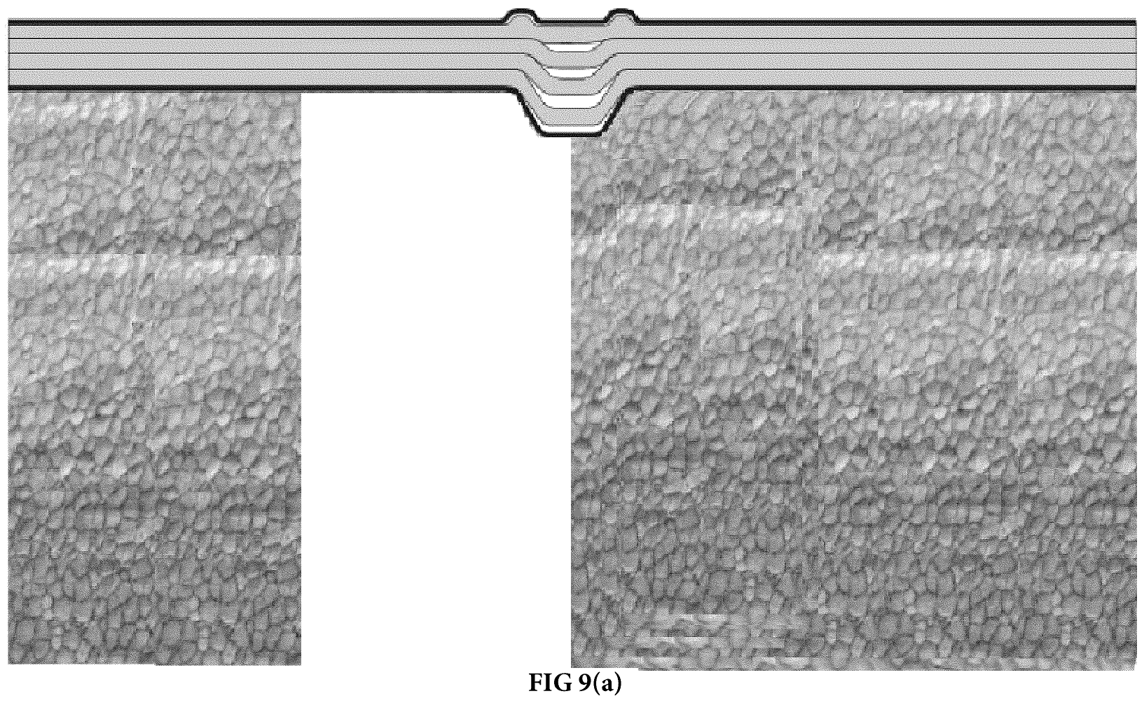

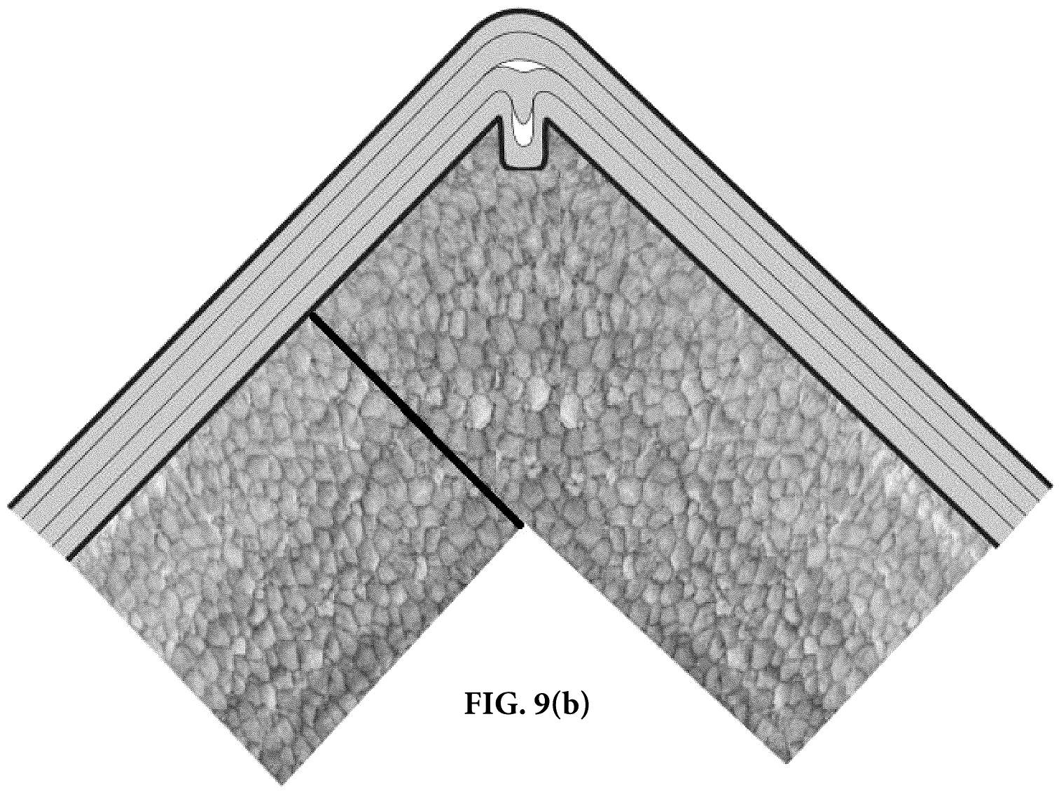

In an alternate embodiment, as reflected in FIGS. 9(a-b), the foam board is comprised of two sections and is mounted in an offset fashion such that the two sections of foam can be folded together during installation. In order to accomplish this end, one of the two sections of foam is smaller than the other. One section is sized such that, when attached, a gap of a width approximately equal to the thickness of foam is left between that section of foam and the pre-scored section. As seen in FIG. 9(b), when such a sheet is folded, as when bent around a corner, the second section of foam “folds” into the gap resulting in the creation of an essentially continuous insulative barrier around the corner.

It will further be noted that the insulative foam need not run the entirety of the length or width of the sheet. A margin of varying length may be left between the end of the foam and one or more edges of the sheet. This permits the structural layer of a first insulative sheathing board sheet to overlap the next sheet when in use, thereby eliminating the need to tape the seam. While the edge of a first structural board would overlap the edge of the second sheet, the edge of insulative foam from the first sheet would abut the end of insulative foam from the second sheet. This may be done horizontally or vertically or both.

There are three traditional ways to score a sheet of sheathing. Of course, combinations of these processes and other methods may be used. However, in the preferred embodiment, the scoring is accomplished by pressing a male/female indent in the board resulting in a male bump on one side of the sheathing and an indent recess on the female side of the sheathing. Other scoring methods include cut-scoring and a perforated cut scoring process. Regardless, the scoring creates a controlled weakened line that facilitates the bending of the sheathing around a corner.

In pressing a female score indent (and corresponding male bump on the opposite side), the indent has dimensions of from 1/64″ to 0.125″, or alternatively 1/16″ to 0.500″ in width and 1/32″ to 80% of the thickness of the sheet, or alternatively 1/16″ to 50% of the thickness of the sheet in depth. In cut-scoring or perforating the sheathing, the cuts may have a length of 1/16 to 1″, and the cut depth in the sheathing may be 1/32″ to 80% of the way through the sheet.

As noted, the pre-scoring may be positioned in one particular line on a sheathing board, or there may be multiple different pre-scoring lines on a board in anticipation of different installations that would call for different bending locations. The score may, for example, run the vertical length of the middle of the board.

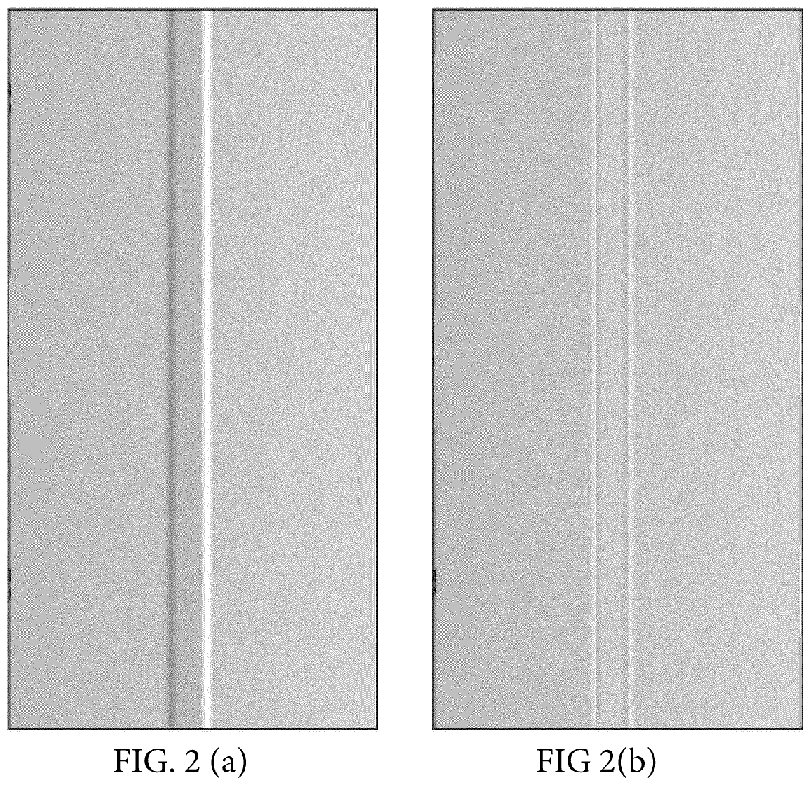

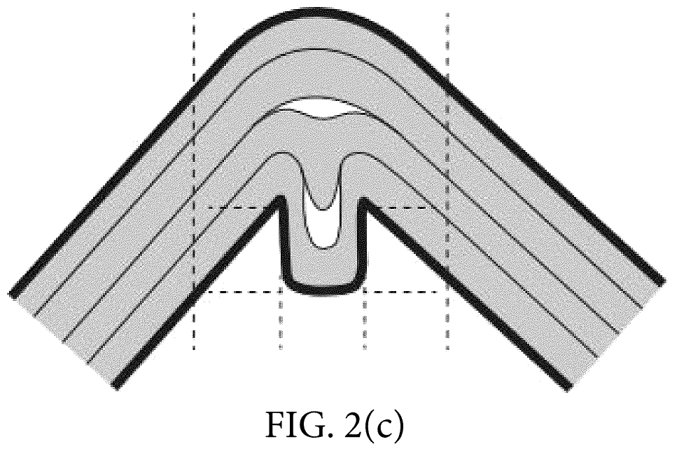

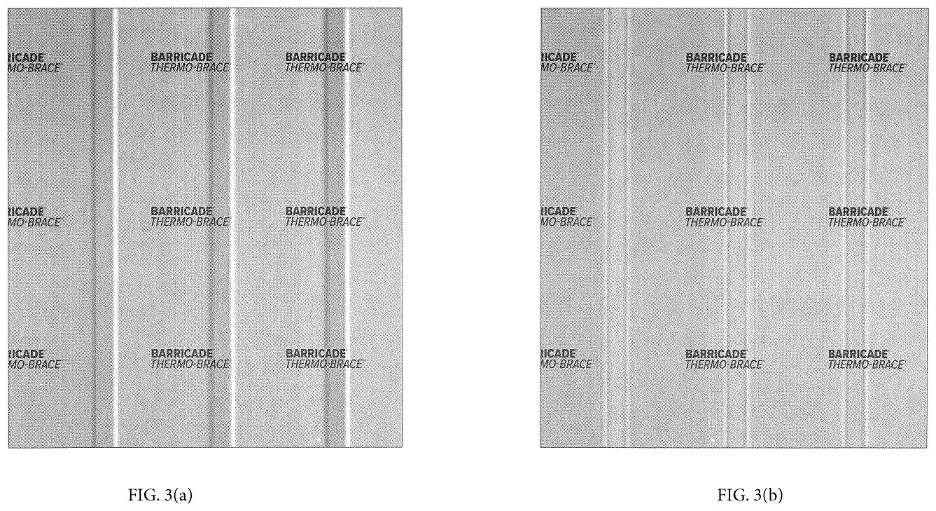

Turning now to the drawings, FIGS. 1 and 2 illustrate a structural sheathing board with FIG. 2 showing the score in a flat and open configuration and in a bent, 90 degree configuration. Of course, the board may be bent more or less than 90 degrees depending on the installation situation, and the score may be deeper or shallower depending on that purpose. In these example boards, there are four fiberboard layers sandwiched between inside and outside water resistant barrier layers. More or fewer layers are possible as well. FIG. 3 show a board with multiple (three) scores that run from the top to the bottom of the board.

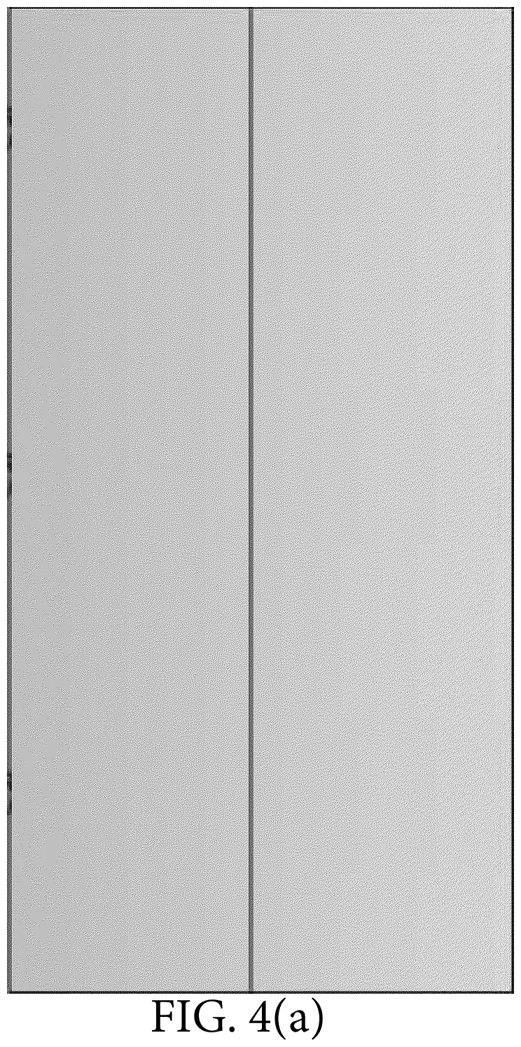

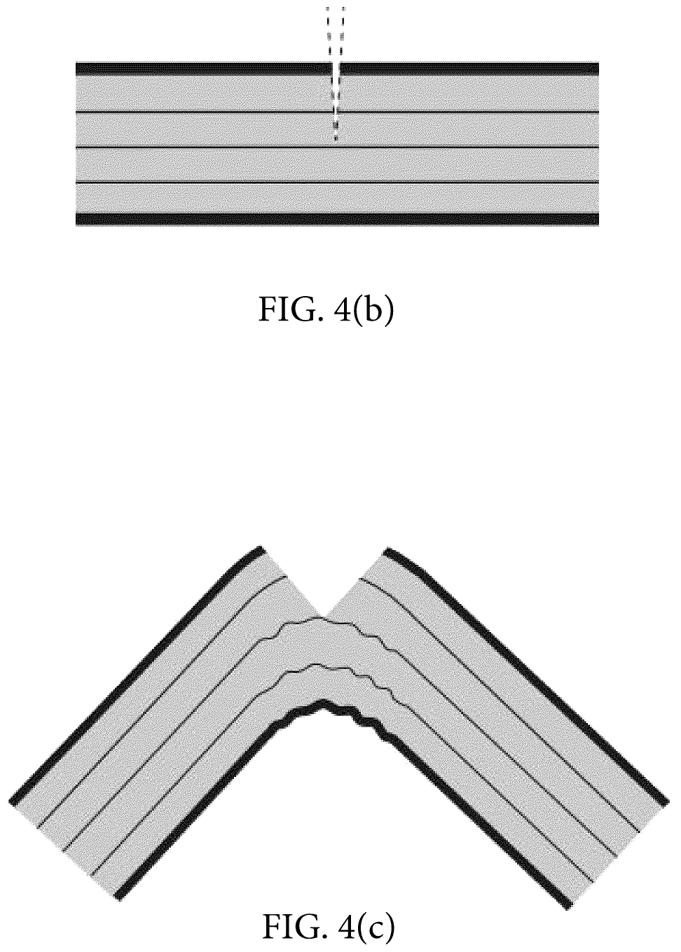

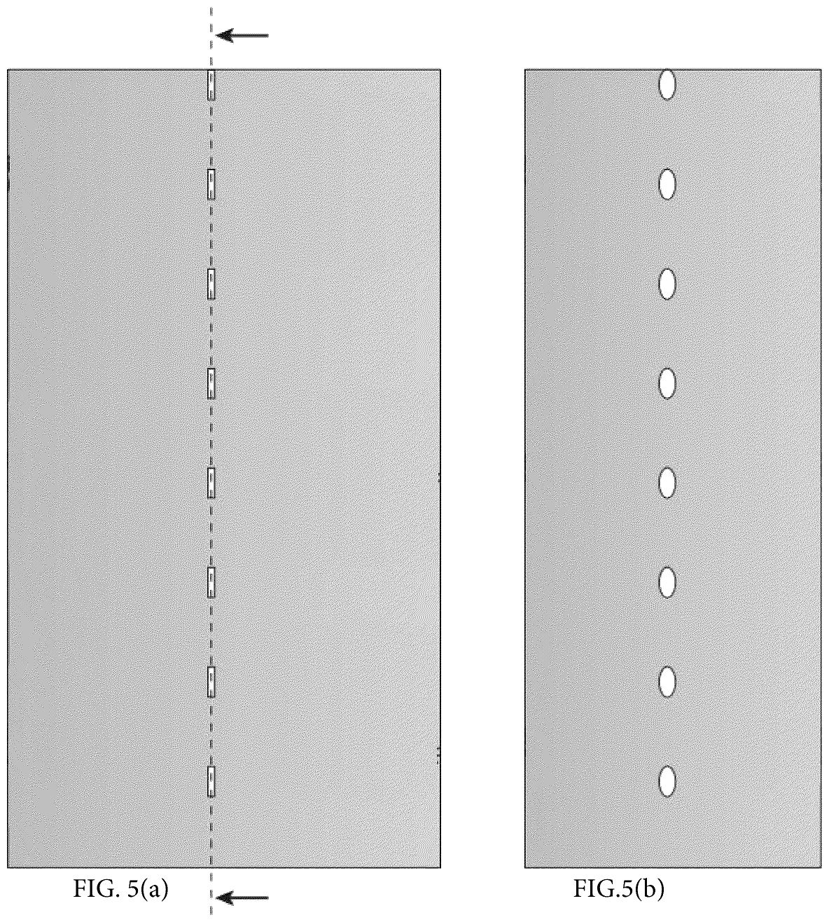

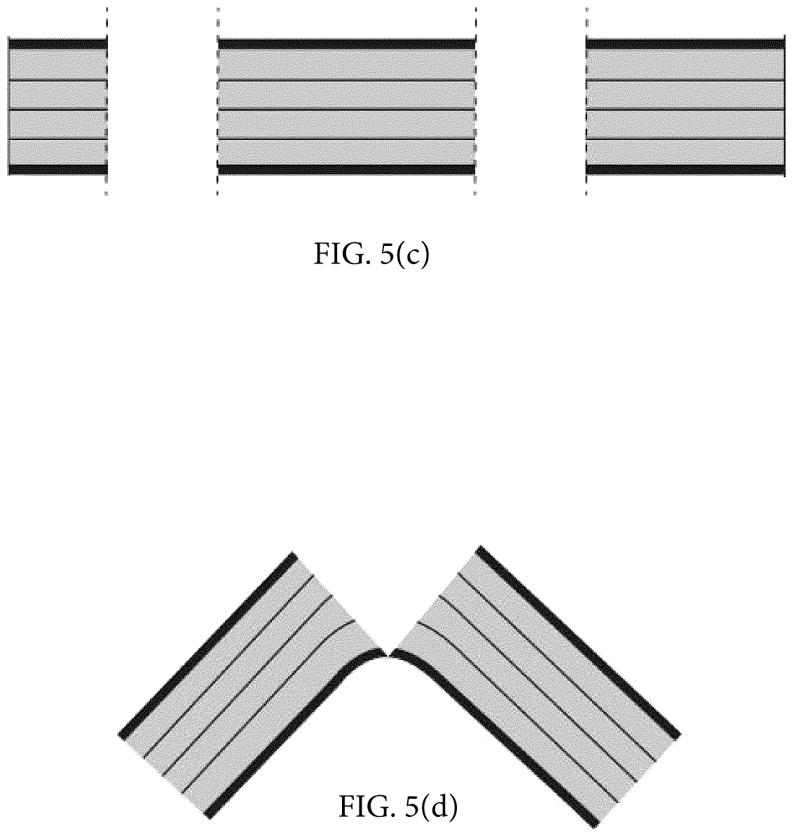

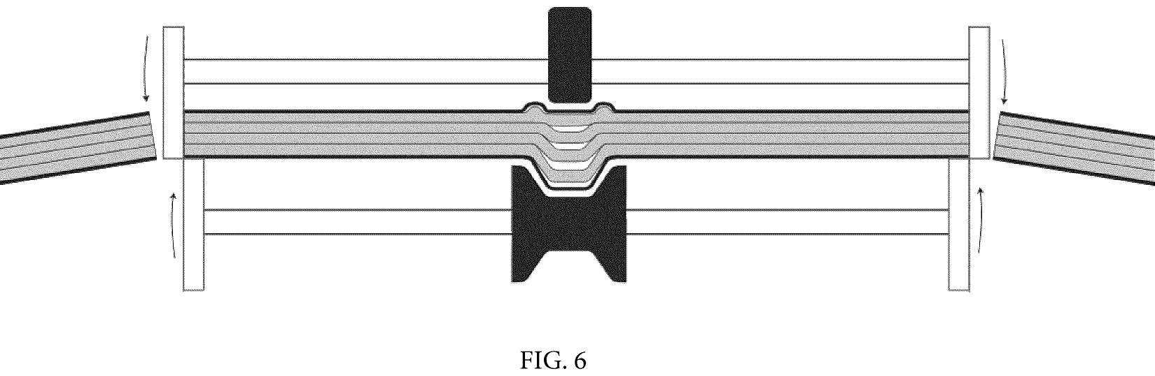

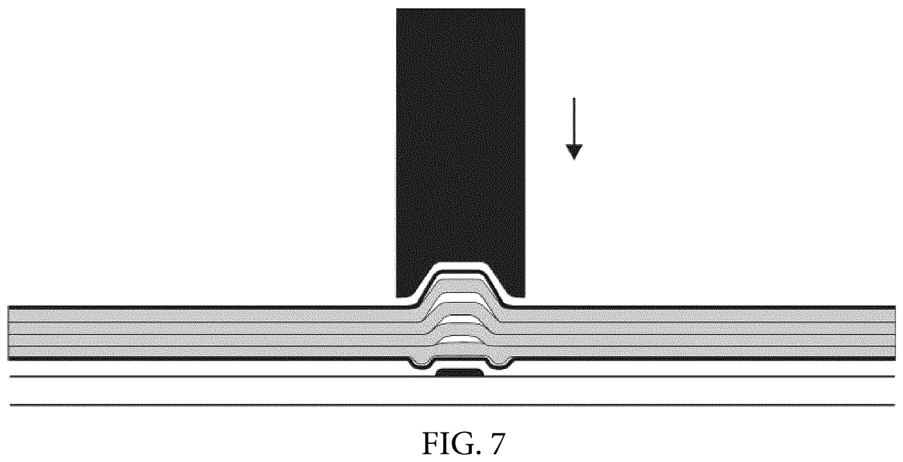

FIG. 4 shows an alternative scoring, cut scoring, where the structural sheathing board has a cut part way through the cross-section of the board to facilitate the bending of the board. FIG. 5 illustrates a perforated scoring that facilitates the bending of the board along the line of perforations. FIGS. 6 and 7 illustrate two of the methods of placing an indented scoring in a board. FIG. 6 illustrates an in-process method where the board passes between rollers that press the indent into the board. FIG. 7 illustrates a stamping method where a fully-constructed board has a rounded point pushed into a channel to create the scoring.

FIGS. 8 and 9 illustrate an insulated structural sheathing board where a layer of insulative foam is attached to one side of the structural component board. In order to facilitate bending, a V-shape is cut out of the insulative board with the point of the V-cut proximate the board scoring. In FIG. 8(a) the board is flat, while FIG. 8(b) shows the board in a bent configuration and the foam closed onto itself. FIGS. 9(a-b) reflect off-set mounted insulated foam which provides clearance for the foam to fold together when installed in a bent configuration (as reflected in FIG. 9(b)).

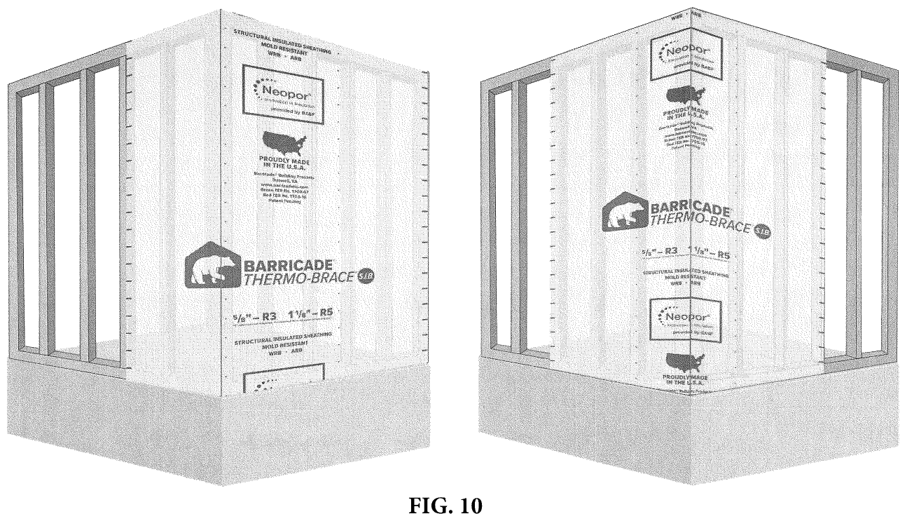

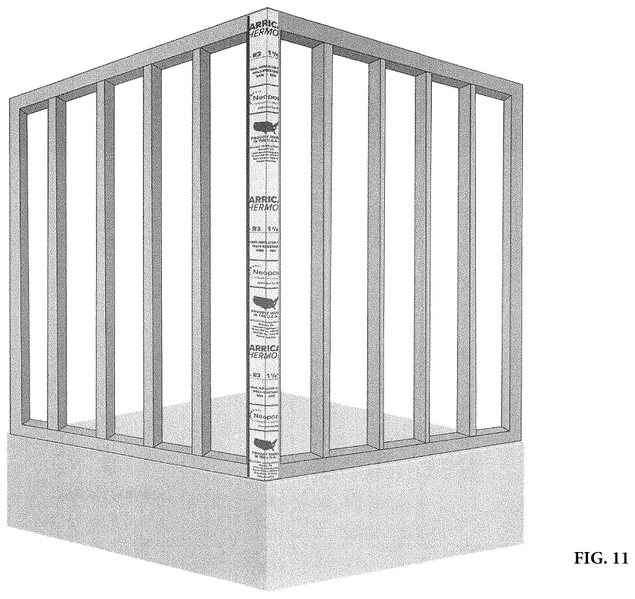

FIGS. 10 and 11 illustrates embodiments of structural sheathing board mounted on the corners of a room or building. FIG. 10 illustrates over-sized structural boards that are scored and bent around a wall corner. FIG. 11 illustrates a special-sized thin board.

Other embodiments of the present invention will be apparent to those skilled in the art from consideration of the specification. It is intended that the specification and figures be considered as exemplary only, with a true scope and spirit of the invention being indicated by the following claims.

What is claimed is:

1. A structural sheathing board having at least one hinge created by a pre-scored line across the width or length of the sheathing board.

2. A sheet of structural sheathing board comprising: a multi-layered structural portion having a length and a width and an interior face and an exterior face, and, further having at least one pre-scored line to facilitate bending of the sheet without fracturing or damaging the exterior surface of such sheet.

3. The sheet of structural sheathing board of claim 2 wherein said multi-layer structural portion is comprised of at least two layers.

4. The sheet of structural sheathing board of claim 3 wherein said multi-layer structural portion is comprised of least one water-resistant layer.

5. The sheet of structural sheathing board of claim 3 wherein each of the at least two layers are formed from one of the group of polyolefins, polyester, polyethylene, polypropylene, fiberboard, or paper.

6. The sheet of structural sheathing board of claim 5 wherein the sheet has a thickness range of 0.050 to 0.200 inches.

7. The sheet of structural sheathing board of claim 3 further comprising an insulative foam layer having a first side and a second side wherein the first side of said foam layer is attached to the interior face of said multi-layer structural portion.

8. The sheet of structural sheathing board of claim 7 wherein a V-shaped portion, having an apex proximate to said at least one pre-scored line of said sheathing board, has been removed from said insulative foam layer.

9. The sheet of structural sheathing board of claim 7 wherein said insulative foam layer is comprised of first and second sections; said first section having an edge which is essentially flush with said pre-scored section; and, said second section having an edge positioned at such location that a space essentially equal to the thickness of the foam layer exists between the edge of the second section and the pre-scored line.

10. The sheet of structural sheathing board of claim 7 wherein said insulative foam layer is sized such that there is a gap between at least one edge of said insulative foam and an edge of said multi-layer structural portion.

11. The sheet of structural sheathing board of claim 2 wherein the dimensions of said sheet are essentially 4′ wide by 8′ long.

12. The sheet of structural sheathing board of claim 11 further comprising a width flap; said width flap extending the width of said sheet beyond said 4′ width.

13. The sheet of structural sheathing board of claim 11 further comprising a length flap; said length flap extending the length of said sheet beyond said 8′ length.

14. The sheet of structural sheathing board of claim 2 wherein said at least one pre-scored line extends along the entirety of said width or said length.

15. The sheet of structural sheathing board of claim 2 wherein said at least one pre-scored line extends from one edge of the sheet to another edge of the sheet.

16. A sheet of structural sheathing board comprising: a multi-layered structural portion having a length and a width and an interior face and an exterior face, and, further having at least one hinge to facilitate controlled bending along at least one of a horizontal axis or vertical axis of the sheet.

17. The sheet of structural sheathing board of claim 16 further comprising an insulative foam layer having a first side and a second side wherein the first side of said foam layer is attached to the interior face of said multi-layer structural portion.

18. A method of pre-scoring structural sheathing board, the method comprising:
selecting a scoring process from the group of pressing a score indent, cut scoring, and perforated cut scoring; and,
using the selected scoring process to create at least one pre-scored line across the entirety of the width or length of said sheathing board,
whereby the selected scoring process creates a controlled weakened line that serves as a hinge to facilitate the bending of the sheathing board around a corner.
